(19) United States
(12) Patent Application Publication
(10) Pub. No.: US 2012/0249840 A1
(43) Pub. Date: Oct. 4, 2012

(54) ELECTRONIC CAMERA

(75) Inventor: Makoto Hirata, Yawata-shi (JP)

(73) Assignee: SANYO ELECTRIC CO., LTD., Moriguchi-shi (JP)

(21) Appl. No.: 13/435,536

(22) Filed: Mar. 30, 2012

(30) Foreign Application Priority Data
Mar. 31, 2011 (JP) 2011-078782

(51) Int. Cl. H04N 5/262

(52) U.S. Cl. 348/239; 348/E05.056

(57) ABSTRACT

An electronic camera includes an imager. An imager captures a scene. A positioner measures a current position. A first creator creates a first image representing the scene captured by the imager in response to a first instruction. A second creator creates a second image including a first partial image associated with the position measured by the positioner, in response to a second instruction. An assigner assigns position information indicating the position measured by the positioner to each of the first image created by the first creator and the second image created by the second creator.

### CROSS REFERENCE OF RELATED APPLICATION

The disclosure of Japanese Patent Application No. 2011-78782, which was filed on Mar. 31, 2011, is incorporated herein by reference.

### BACKGROUND OF THE INVENTION

1. Field of the Invention

The present invention relates to an electronic camera, and in particular, relates to an electronic camera which assigns position information to an image.

2. Description of the Related Art

According to one example of this type of camera, when a memory reproducing request is issued in a camera, a plurality of photographed images are transmitted from the camera to a server. Based on shooting date and time and a shooting position of each photographed images, a two-dimensional map image is selected from an age-group map DB. A moving route and a means of transportation of a user at a time of shooting are searched by a route searching section from the two-dimensional map image. An image of a specific position of the searched moving route is created by a virtual landscape creating section. One image file is generated from a series of images created by the virtual landscape creating section and is displayed on a display section of the camera.

However, in the above-described camera, a position which was not shot is not considered, and therefore, there is a possibility that the moving route of the user is erroneously searched for. Thereby, an image reproducing performance may be deteriorated.

### SUMMARY OF THE INVENTION

An electronic camera according to the present invention comprises: an imager which captures a scene; a positioner which measures a current position; a first creator which creates a first image representing the scene captured by the imager in response to a first instruction; a second creator which creates a second image including a first partial image associated with the position measured by the positioner, in response to a second instruction; and an assigner which assigns position information indicating the position measured by the positioner to each of the first image created by the first creator and the second image created by the second creator.

According to the present invention, an image creating program recorded on a non-transitory recording medium in order to control an electronic camera provided with an imager which captures a scene, the program causing a processor of the electronic camera to perform the steps comprises: a positioning step of measuring a current position; a first creating step of creating a first image representing the scene captured by the imager in response to a first instruction; a second creating step of creating a second image including a first partial image associated with the position measured by the positioning step, in response to a second instruction; and an assigning step of assigning position information indicating the position measured by the positioning step to each of the first image created by the first creating step and the second image created by the second creating step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a configuration of a register referred to by the embodiment in FIG. 2;

FIG. 4 is an illustrative view showing one example of an assignment state of an evaluation area in an imaging surface;

FIG. 5 is an illustrative view showing one example of a scene image captured by the imaging surface;

FIG. 6 is an illustrative view showing one example of a position information image;

FIG. 7 is an illustrative view showing another example of the position information image;

FIG. 8 is an illustrative view showing one example of a configuration of a table referred to by the embodiment in FIG. 2;

FIG. 9 is an illustrative view showing one example of a position information image after a composing process;

FIG. 10 is an illustrative view showing one example of a state where a taken image and the position information image are displayed as thumbnails on an electronic map;

FIG. 11 is a flowchart showing one portion of behavior of a CPU applied to the embodiment in FIG. 2;

FIG. 12 is a flowchart showing another portion of behavior of the CPU applied to the embodiment in FIG. 2;

FIG. 13 is a flowchart showing one portion of behavior of another CPU applied to the embodiment in FIG. 2;

FIG. 14 is a flowchart showing another portion of behavior of another CPU applied to the embodiment in FIG. 2;

FIG. 15 is a flowchart showing still another portion of behavior of another CPU applied to the embodiment in FIG. 2;

FIG. 16 is a flowchart showing yet another portion of behavior of another CPU applied to the embodiment in FIG. 2;

FIG. 17 is a flowchart showing another portion of behavior of another CPU applied to the embodiment in FIG. 2; and

FIG. 18 is a block diagram showing a configuration of another embodiment of the present invention;

### DETAILED DESCRIPTION OF THE PREFERRED EMBODIMENTS

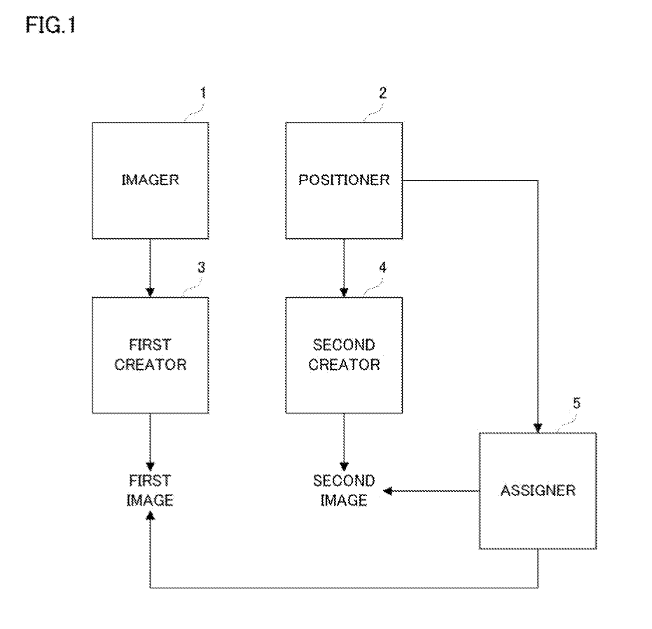

With reference to FIG. 1, an electronic camera according to one embodiment of the present invention is basically configured in the following manner. An imager 1 captures a scene. A positioner 2 measures a current position. A first creator 3 creates a first image representing the scene captured by the imager 1 in response to a first instruction. A second creator 4 creates a second image including a first partial image associated with the position measured by the positioner 2, in response to a second instruction. An assigner 5 assigns position information indicating the position measured by the positioner 2 to each of the first image created by the first creator 3 and the second image created by the second creator 4.

When the first instruction is accepted, the first image representing the scene and the position information assigned thereof are acquired. Moreover, when the second instruction is accepted, the second image including the first partial image associated with a current position and the position information assigned thereof are acquired. Thereby, it becomes possible to execute a common image reproducing process referring to the position information to the first image and the second image. Thus, an image reproducing performance is improved.

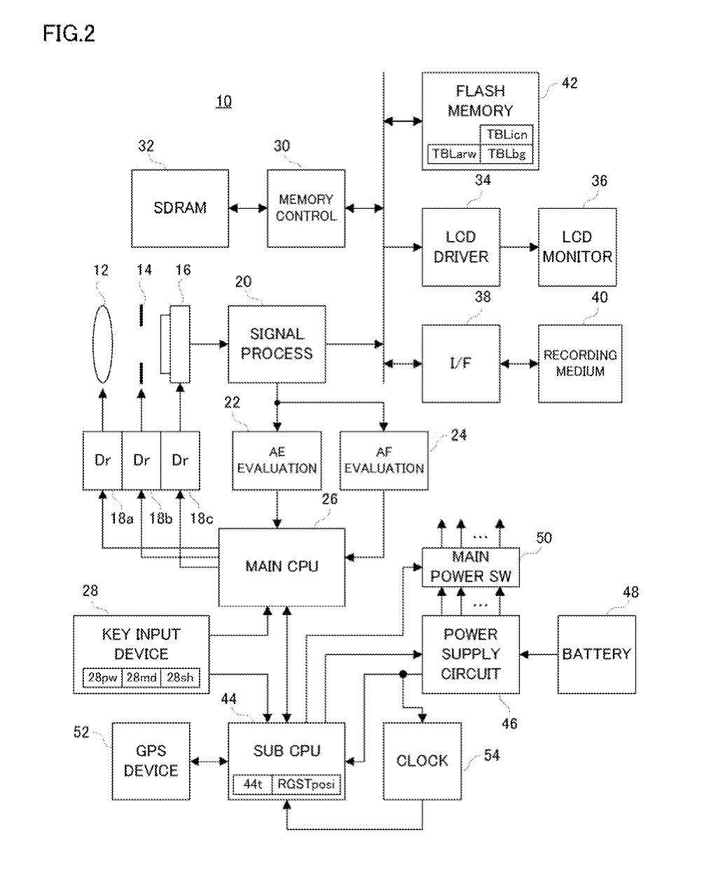

With reference to FIG. 2, a digital camera 10 according to one embodiment includes a power supply circuit 46. The power supply circuit 46 generates a plurality of direct current power supplies, each of which shows a different voltage value, based on a battery 48. One portion of the plurality of generated direct current power supplies is directly applied to a sub CPU 44, and another portion of the plurality of generated direct current power supplies is applied to the entire system via a main power switch 50. Therefore, the sub CPU 44 is activated all the times, whereas elements configuring the entire system are activated/stopped in response to turning on/off of the main power switch 50.

The sub CPU 44 repeatedly executes resetting and starting a timer 44t by setting a timer value to 15 minutes, and measures a current position of the digital camera 10 in a following manner when time-out has occurred in the timer 44t. It is noted that, a period of 15 minutes set as the timer value is an exemplification, and a period different from 15 minutes may be set.

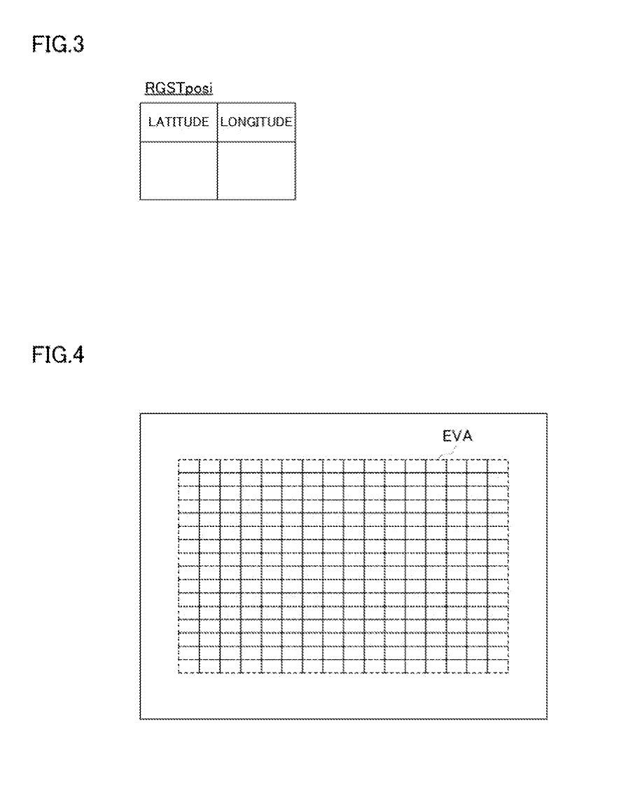

Firstly, the sub CPU 44 issues a measuring command toward a GPS device 52. The GPS device 52 which has accepted the measuring command measures a current position with reference to a signal transmitted from a plurality of GPS satellites in the sky and sends back the measured result to the sub CPU 44. The sub CPU 44 acquires latitude and longitude indicating the current position of the digital camera 10 based on the sent back measured result. The acquired latitude and longitude are registered on a register RGSTposi shown in FIG. 3.

When a power-on operation is performed by a power button 28pw on a key input device 28, the sub CPU 44 activates the entire system including a main CPU 26 by controlling the main power switch 50. Moreover, the sub CPU 44 executes measuring and registering the above-described current position and resetting and starting the timer 44t as well when activating the entire system.

When the entire system is activated, under a main task, the main CPU 26 determines a state of a mode changing button 28md arranged in the key input device 28 (i.e., an operation mode at a current time point) so as to activate an imaging task corresponding to an imaging mode whereas activate a reproducing task corresponding to a reproducing mode.

When the imaging task is activated, in order to execute a moving-image taking process, the main CPU 26 commands a driver 18c to repeat an exposure procedure and an electric-charge reading-out procedure under the imaging task. In response to a vertical synchronization signal Vsync periodically generated from an SG (Signal Generator) not shown, the driver 18c exposes an imaging surface and reads out electric charges produced on the imaging surface in a raster scanning manner. From an image sensor 16, raw image data based on the read-out electric charges is cyclically outputted.

A signal processing circuit 20 performs processes, such as digital clamp, pixel defect correction, gain control and etc., on the raw image data outputted from the image sensor 16. The raw image data on which these processes are performed is written into an SDRAM 32 through a memory control circuit 30. Furthermore, the signal processing circuit 20 reads out the raw image data stored in the SDRAM 32 through the memory control circuit 30 and performs processes, such as color separation, white balance adjustment, and YUV conversion, on the read-out raw image data so as to create display image data that comply with the YUV format. The display image data is written into the SDRAM 32 through the memory control circuit 30.

An LCD driver 34 repeatedly reads out the display image data stored in the SDRAM 32 through the memory control circuit 30, and drives an LCD monitor 36 based on the read-out image data. As a result, a real-time moving image (a live view image) of the scene is displayed on the LCD monitor 36.

With reference to FIG. 4, an evaluation area EVA is assigned to a center of the imaging surface. Moreover, in addition to the above-described processes, the signal processing circuit 20 executes a simple RGB converting process which simply converts the raw image data into RGB data.

An AE evaluating circuit 22 integrates RGB data belonging to the evaluation area EVA, out of the RGB data produced by the signal processing circuit 20, at every time the vertical synchronization signal Vsync is generated. Thereby, 256 integral values (256 AE evaluation values) are outputted from the AE evaluating circuit 22 in response to the vertical synchronization signal Vsync. An AF evaluating circuit 24 integrates a high-frequency component of RGB data belonging to the evaluation area EVA, out of the RGB data outputted from the signal processing circuit 20 at every time the vertical synchronization signal Vsync is generated. Thereby, 256 integral values (256 AF evaluation values) are outputted from the AF evaluating circuit 24 in response to the vertical synchronization signal Vsync.

When a shutter button 28sh is in a non-operated state, the main CPU 26 executes a simple AE process that is based on output from the AE evaluating circuit 22 so as to calculate an appropriate EV value. The simple AE process is executed in parallel with the moving-image taking process, and an aperture amount and an exposure time period that define the calculated appropriate EV value are set to the drivers 18b and 18c, respectively. As a result, a brightness of a live view image is adjusted approximately.

When the shutter button 28sh is half-depressed, the main CPU 26 executes a strict AE process that is based on output from the AE evaluating circuit 22. An aperture amount and an exposure time period that define an optimal EV value calculated by the strict AE process are set to the drivers 18b and 18c, respectively. As a result, the brightness of the live view image is adjusted strictly.

Upon completion of the strict AE process, the main CPU 26 executes an AF process that is based on output from the AF evaluating circuit 24. As a result, a focus lens 12 is placed at a focal point, and a sharpness of the live view image is improved.

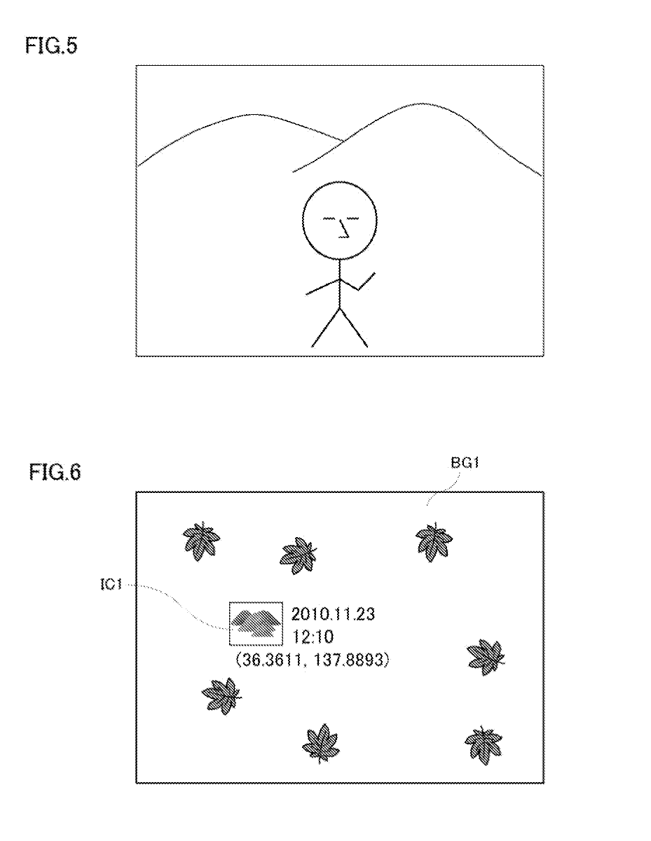

When the shutter button 28sh is fully depressed after completion of the AF process, under the imaging task, the main CPU 26 executes a still-image taking process and a recording process. With reference to FIG. 5, one frame of image data at a time point at which the shutter button 28sh is fully depressed is taken into the SDRAM 32 by the still-image taking process.

Subsequently, the main CPU 26 acquires, through the sub CPU 44, the latitude and longitude indicating the current position registered in the register RGSTposi and a current date and time indicated by a clock circuit 54. Moreover, the main CPU 26 creates a header of a still image file by using the acquired latitude, longitude, date and time. The latitude, longitude, date and time are described in an Exif (Exchangeable Image File Format) tag in the header.

The main CPU 26 creates the still image file within a recording medium 40 by using the header thus created. One frame of image data taken by the still-image taking process is read out from the SDRAM 32 by an I/F 38 activated in association with the recording process, and is written into the created still image file.

When a power-off operation is performed by the power button 28pw, the main CPU 26 ends the imaging task, and the sub CPU 44 stops the entire system by controlling the main power switch 50.

In a case where the entire system is in a stopped state when the latitude and longitude indicating the current position are acquired, the sub CPU 44 sets a flag FLGend to “0” so as to activate the entire system including the main CPU 26 by controlling the main power switch 50. In this case, the main CPU 26 executes a position recording process in a following manner irrespective of a selection state of the mode setting switch 28md arranged in the key input device 28.

Firstly, the main CPU 26 acquires, through the sub CPU 44, the latitude and longitude indicating the current position registered in the register RGSTposi and a current date and time indicated by a clock circuit 54.

Subsequently, the main CPU 26 creates a position information image by using the acquired latitude, longitude, date and time. Moreover, upon creating the position information image, a table TBLicn and a table TBLbg stored in a flash memory 42 are referred to.

In the table TBLicn, a plurality of images are respectively assigned to a plurality of areas each of which is represented by a combination of a range of latitude and a range of longitude. Each of the plurality of images is an iconized image which symbolizes a corresponding area, and is stored in the flash memory 42. In the table TBLbg, a plurality of images are respectively assigned to a plurality of seasons each of which are represented by a range of dates. Each of the plurality of images is an image for a background, which symbolizes a corresponding season, and is stored in the flash memory 42.

The main CPU 26 specifies an icon image IC corresponding to the acquired latitude and longitude, with reference to the table TBLicn. Moreover, the main CPU 26 specifies a background BG corresponding to the acquired date, with reference to the table TBLbg. Furthermore, the main CPU 26 visualizes character strings indicating the acquired latitude, longitude, date and time.

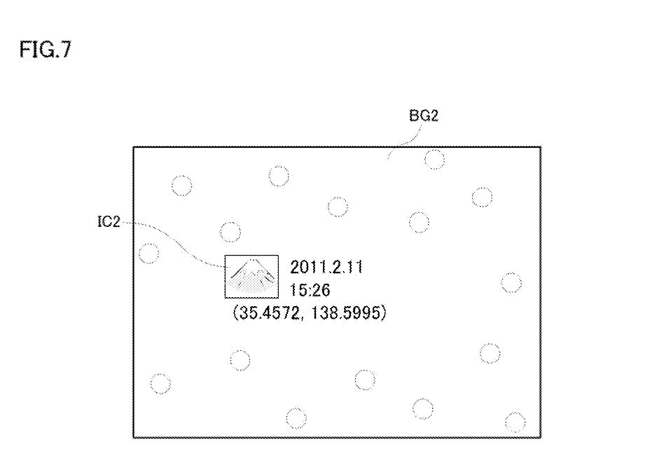

The CPU 26 creates a position information image by combining the icon IC and the background BG thus specified and the visualized character strings. According to an example shown in FIG. 6, since an area indicated by the acquired latitude and longitude is a mountainous area, an icon IC1 representing mountains is specified. Moreover, since a season indicated by the acquired date is the foliage season, a background BG1 representing maples is specified. According to an example shown in FIG. 7, since an area indicated by the acquired latitude and longitude is near Mount Fuji, an icon IC2 representing Mount Fuji is specified. Moreover, since a season indicated by the acquired date is the middle of winter, a background BG2 representing snowing is specified.

Image data showing the position information image thus created is written into the SDRAM 32 through the memory control circuit 30.

Moreover, the main CPU 26 creates the header of the still image file by using the acquired latitude, longitude, date and time. The latitude, longitude, date and time are described in the Exif tag in the header.

The main CPU 26 creates the still image file within the recording medium 40 by using the header thus created. The image data showing the created position information image is read out from the SDRAM 32 by the I/F 38 activated in association with the position recording process, and is written into the created still image file. Upon completion of writing into the still image file, the main CPU 26 sets the flag FLGend to “1”, and the sub CPU 44 stops the entire system by controlling the main power switch 50.

It is noted that a distance between the current position acquired from the register RGSTposi and a position indicated by the latitude and longitude described in the Exif tag of the latest still image file showing the taken image or the position information image indicates a moving distance of the digital camera 10. When the moving distance has not exceeded a threshold value THd, the position information recording process is ended without a position information image being newly created. The threshold value THd is set to 300 meters, for example.

Moreover, the main CPU 26 calculates a moving direction of the digital camera 10 by referring to the current position acquired from the register RGSTposi and the position indicated by the latitude and longitude described in the Exif tag of the latest still image file. Before a creating process for a new position information image in the position recording process, the main CPU 26 composes an arrow image indicating the calculated moving direction and a still image stored in the latest still image file. Moreover, upon a composing process, a table TBLarw is referred to.

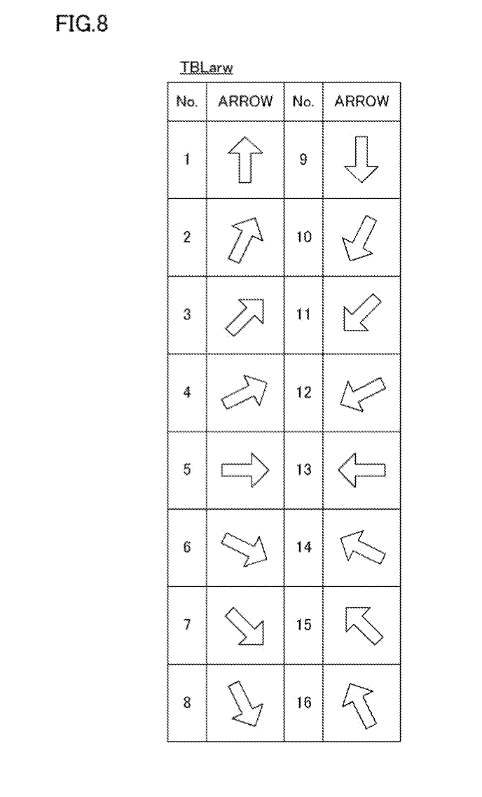

With reference to FIG. 8, in the table TBLarw, 16 arrow images each of which indicates a direction corresponding to an angle every 22.5 degrees from zero degree to 337.5 degrees are stored. It is noted that an arrow image corresponding to zero degree indicates true north.

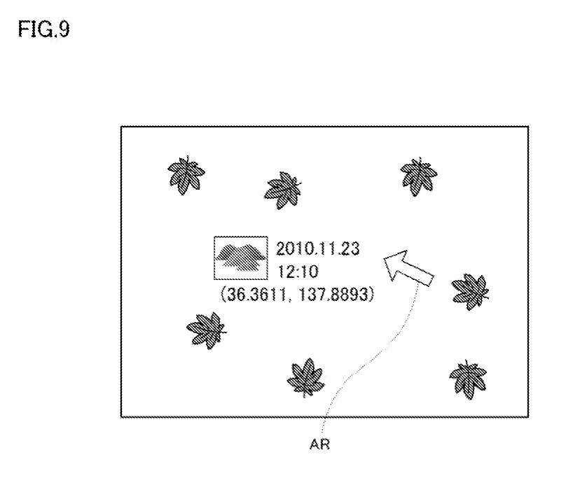

The main CPU 26 specifies an arrow image AR indicating a direction nearest to the calculated moving direction with reference to the table TBLarw. With reference to FIG. 9, the main CPU 26 composes the arrow image AR thus specified and the still image stored in the latest still image file. The composed image is overwritten in the latest still image file. The composing process and the overwriting process are executed as well in the main task after completion of the recording process for the taken image.

It is noted that, when the still image stored in the latest still image file is the taken image, the taken image may be protected by performing the above-described composing process and the overwriting process on one of the still image files after duplicating the latest still image file. Otherwise, in this case, the taken image may be protected by avoiding the above-described composing process and the overwriting process.

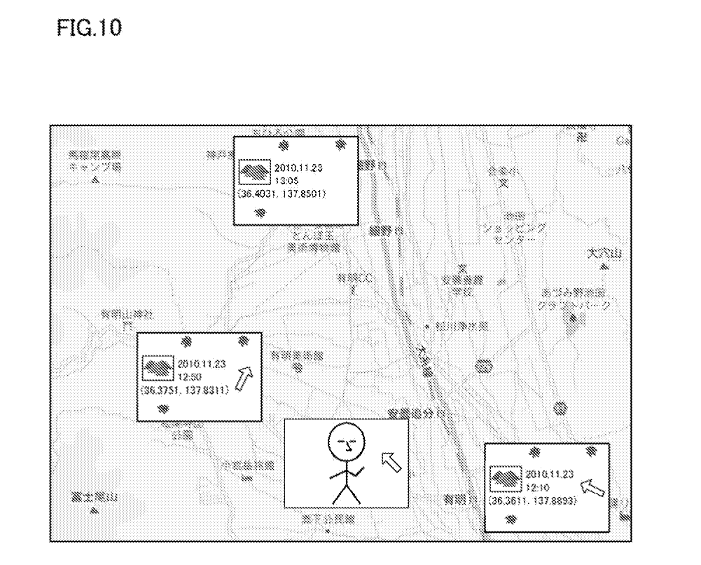

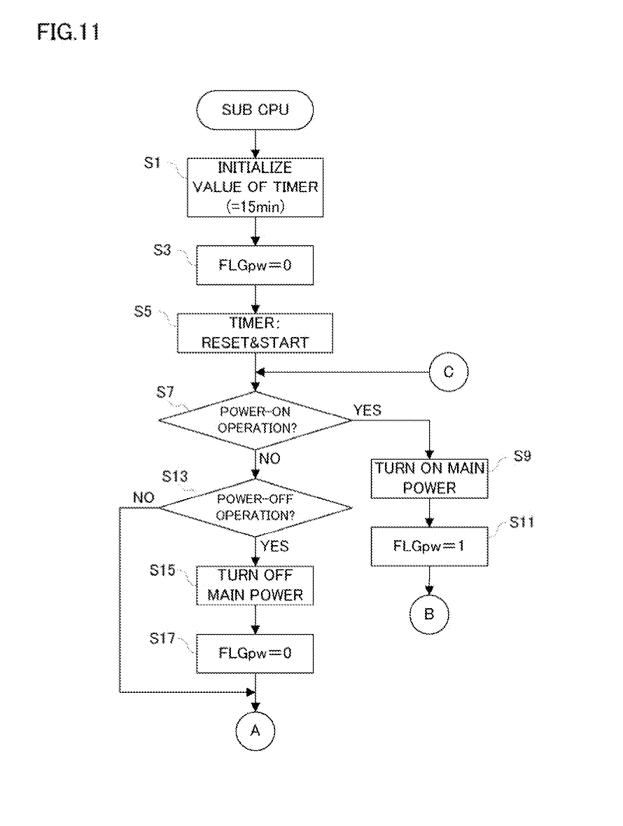

With reference to FIG. 10, in an application software which associates the latitude and longitude described in the Exif tag with latitude information and longitude information of an electronic map, when the still image file indicating the taken image and the still image file indicating the position information image are used, each of the taken image and the position information image is displayed as thumbnails on the map.

According to an example shown in FIG. 10, a still image file indicating a position information image was created at 12:10 on Nov. 23, 2010. Thereafter, an operator moved, and the entire system was activated according to the power-on operation by 12:25 when the time-out occurred in the timer 44t so as to create the still image file indicating the taken image according to the fully-depressing operation for the shutter button 28sh.

Furthermore, when the entire system was activated, performed were measuring and registering the current position and resetting and starting the timer 44t. However, since the operator had moved little for a while, from a position at which the power-on operation was performed, during that time, a distance between a position measured at a time of the time-out occurring in the timer 44t and a position measured at a time of the entire system being activated did not exceed the threshold value THd. As a result, the position information recording process is ended without the position information image being created. Thereafter, by the operator restarting to move, still image files indicating position information images respectively created at 12:50 and 13:5 on the same day.

Thus, it is possible to use the still image file indicating the position information image in order to display the photographed image and a track of the movement of the operator at the same time.

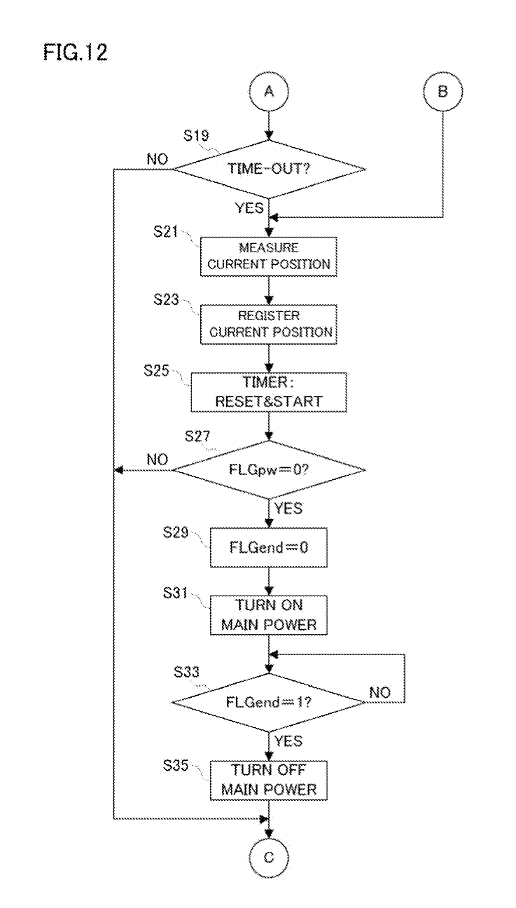

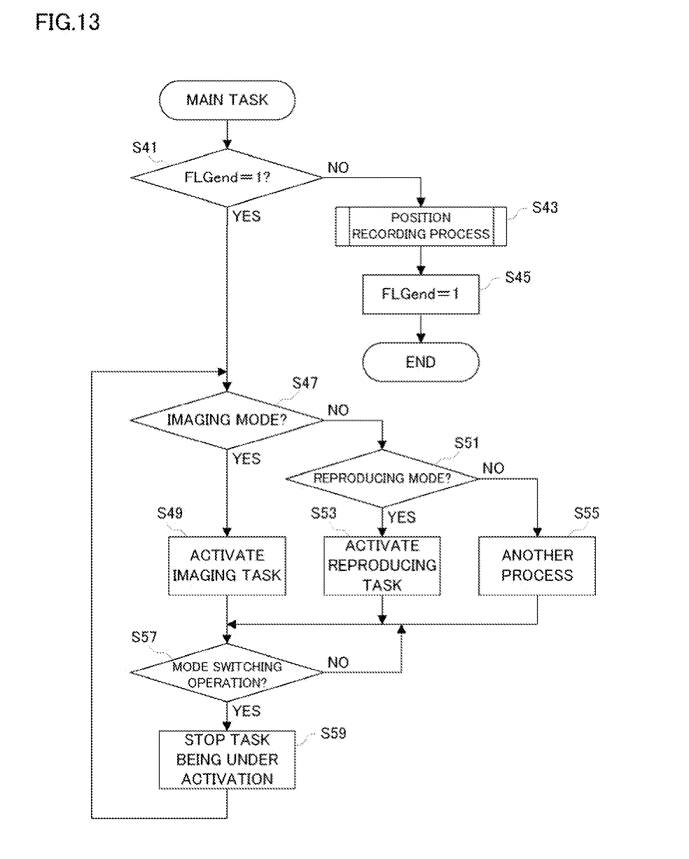

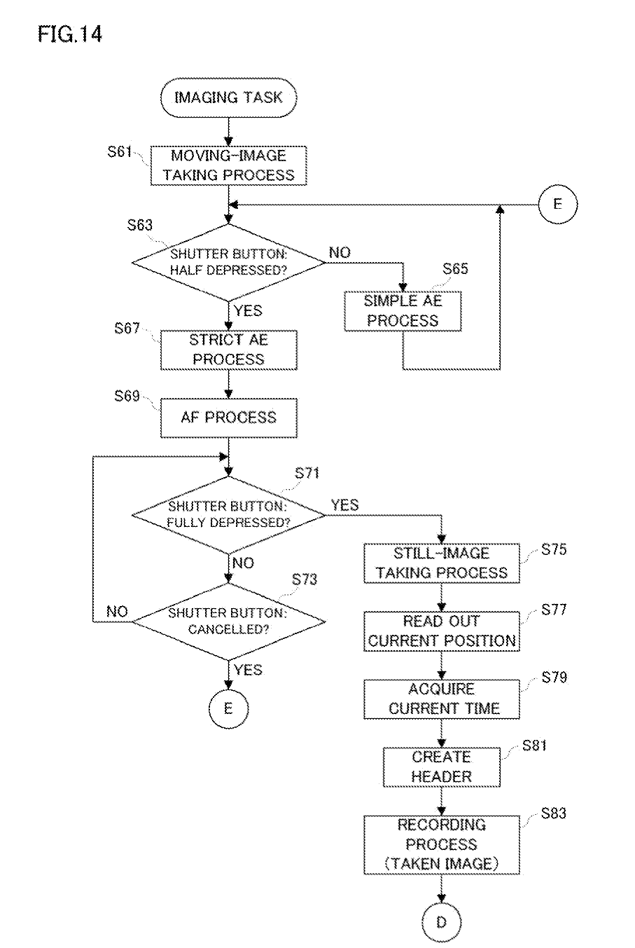

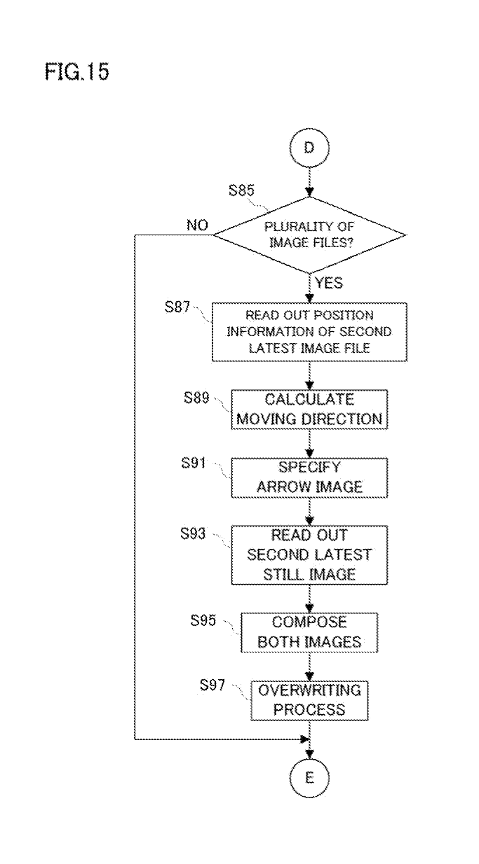

The sub CPU 44 executes processes according to flowcharts shown in FIG. 11 to FIG. 12. Moreover, the CPU 26 executes a plurality of tasks including the main task shown in FIG. 13 and the imaging task shown in FIG. 14 to FIG. 14, in a parallel manner. It is noted that, control programs corresponding to these tasks are stored in the flash memory 42.

With reference to FIG. 11, in step S1, the value of the timer 44t is initialized to “15 minutes”, and in a step S3, the flag FLGpw is set to “0”. In a step S5, resetting and starting the timer 44t is executed.

In a step S7, it is determined whether or not the power-on operation is performed by the power button 28pw on the key input device 28, and when a determined result is NO, the process advances to a step S13 whereas when the determined result is YES, the process advances to a step S9. In the step S9, the entire system including the main CPU 26 is activated by controlling the main power switch 50, and in a step S11, the flag FLGpw is set to “1”. Upon completion of the process in the step S11, thereafter, the process advances to a step S21.

In the step S13, it is determined whether or not the power-off operation is performed by the power button 28pw, and when a determined result is NO, the process advances to a step S19 whereas when the determined result is YES, the process advances to a step S15. In the step S15, the entire system is stopped by controlling the main power switch 50, and in a step S17, the flag FLGpw is set to “0”.

In the step S19, it is determined whether or not the time-out has occurred in the timer 44t, and when a determined result is NO, the process returns to the step S7 whereas when the determined result is YES, the process advances to the step S21. In the step S21, the measuring command is issued toward the GPS device 52 so as to acquire a current position of the digital camera 10 based on the sent back measured result. The acquired latitude and longitude are registered on the register RGSTposi in a step S23. In a step S25, resetting and starting the timer 44t is executed.

In a step S27, it is determined whether or not the flag FLGpw is set to “0”, and when a determined result is NO, the process returns to the step S7 whereas when the determined result is YES, the process advances to a step S29. In the step S29, the flag FLGend is set to “0”, and in a step S31, the entire system including the main CPU 26 is activated by controlling the main power switch 50.

In a step S33, it is determined whether or not the flag FLGend is set to “1”, and when a determined result is updated from NO to YES, in a step S35, the entire system is stopped by controlling the main power switch 50. Upon completion of the process in the step S35, thereafter, the process returns to the step S7.

With reference to FIG. 13, in a step S41, it is determined whether or not the flag FLGend is set to “1”, and when a determined result is YES, the process advances to a step S47 whereas when the determined result is NO, in a step S43, the position recording process is executed. In a step S45, the flag FLGend is set to “1”, and thereafter, the process is ended.

In the step S47, it is determined whether or not an operation mode at a current time point is the imaging mode, and in a step S51, it is determined whether or not an operation mode at a current time point is the reproducing mode. When a determined result of the step S47 is YES, the imaging task is activated in a step S49. When a determined result of the step S51 is YES, in a step S53, the reproducing task is activated. When both of the determined result of the step S47 and the determined result of the step S51 are NO, another process is executed in a step S55.

Upon completion of the process in the step S49, S53 or S55, in a step S57, it is repeatedly determined whether or not the mode changing button 28md is operated. When a determined result is updated from NO to YES, in a step S59, the task being under activation is stopped, and thereafter, the process returns to the step S47.

With reference to FIG. 14, in a step S61, in order to execute the moving-image taking process, the driver 18c is commanded to repeat the exposure procedure and the electric-charge reading-out procedure under the imaging task. As a result, raw image data based on the read-out electric charges is cyclically outputted from the image sensor 16.

In a step S63, it is determined whether or not the shutter button 28sh is half-depressed, and when a determined result is NO, in a step S65, the simple AE process is executed along with an AE reference. As a result, a brightness of a live view image is adjusted approximately.

When a determined result of the step S63 is updated from NO to YES, in a step S67, the strict AE process is executed. As a result, the brightness of the live view image is adjusted strictly.

In a step S69, the AF process is executed. As a result, the focus lens 12 is placed at a focal point, and a sharpness of the live view image is improved.

In a step S71, it is determined whether or not the shutter button 28sh is fully depressed, and when a determined result is NO, in a step S73, it is determined whether or not the shutter button 28sh is cancelled. When a determined result of the step S73 is NO, the process returns to the step S71 whereas when the determined result of the step S73 is YES, the process returns to the step S63.

When the determined result of the step S71 is YES, in a step S75, the still-image taking process is executed. Thereby, one frame of image data immediately after the shutter button 28sh is fully depressed is taken into the SDRAM 32.

In a step S77, latitude and longitude indicating the current position registered in the register RGSTposi are acquired through the sub CPU 44. In a step S79, a current date and time indicated by the clock circuit 54 is acquired through the sub CPU 44. In a step S81, the header of the still image file is created by using the acquired latitude, longitude, date and time. The latitude, longitude, date and time are described in the Exif tag in the header.

In a step S83, the recording process is executed by using the header thus created. In the recording process, the still image file is created within the recording medium 40. One frame of image data taken by the still-image taking process is read out from the SDRAM 32 by the I/F 38 activated in association with the recording process, and is written into the created still image file.

In a step S85, it is determined whether or not a plurality of still image files are stored in the recording medium 40, and when a determined result is NO, the process returns to the step S63 whereas when the determined result is YES, the process returns to the step S63 via steps S87 to 97.

In the step S87, the latitude and longitude described in the Exif tag of the latest still image file stored in the recording medium 40 are read out through the I/F 38. In the step S89, a moving direction of the digital camera 10 is calculated by referring to the current position read out in the step S77 and the position read out from the still image file in the step S87.

In the step S91, the arrow image AR indicating a direction nearest to the moving direction calculated in the step S89 is specified with reference to the table TBLarw, and in the step S93, a still image stored in the second latest still image file is read out. In the step S95, the arrow image AR specified in the step S91 and the still image read out in the step S93 are composed. In the step S97, the composed image is overwritten in the second latest still image file. Upon completion of the process in the step S97, thereafter, the process returns to the step S63.

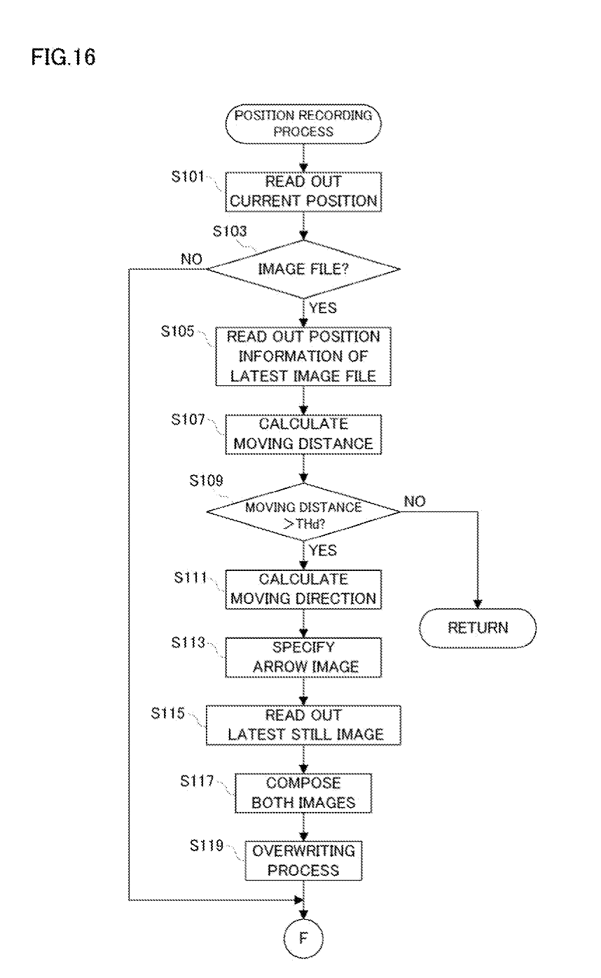

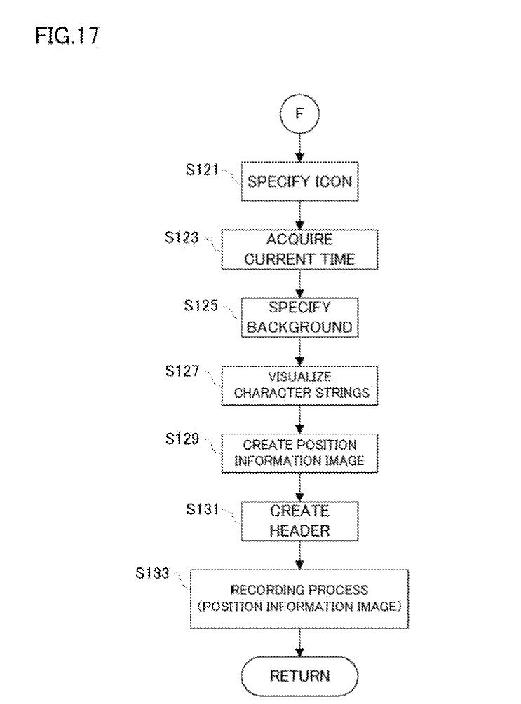

The position recording process in the step S43 is executed according to a subroutine shown in FIG. 16. In a step S101, latitude and longitude indicating the current position registered in the register RGSTposi are read out through the sub CPU 44. In a step S103, it is determined whether or not the still image file is stored in the recording medium 40, and when a determined result is NO, the process advances to a step S121 whereas when the determined result is YES, the process advances to a step S105.

In the step S105, the latitude and longitude described in the Exif tag of the latest still image file showing the taken image or the position information image stored in the recording medium 40 are read out through the I/F 38. In a step S107, a distance between the current position read out in the step S101 and the position read out from the still image file in the step S105 is calculated, and in a step S109, it is determined whether or not the calculated distance exceeds the threshold value THd. When a determined result is YES, the process advances to a step S111 whereas when the determined result is NO, the process returns to the routine in an upper hierarchy.

In the step S111, the moving direction of the digital camera 10 is calculated by referring to the current position read out in the step S101 and the position read out from the still image file in the step S105.

In a step S113, the arrow image AR indicating a direction nearest to the moving direction calculated in the step S111 is specified with reference to the table TBLarw, and in a step S115, a still image stored in the latest still image file is read out. In a step S117, the arrow image AR specified in the step S113 and the still image read out in the step S115 are composed. In a step S119, the composed image is overwritten in the second latest still image file.

In the step S121, the icon image IC corresponding to the latitude and longitude read out in the step S101 is specified with reference to the table TBLicn. In a step S123, a current date and time indicated by the clock circuit 54 is acquired through the sub CPU 44.

In a step S125, the background BG corresponding to the date acquired in the step S123 is specified with reference to the table TBLbg. In a step S127, character strings indicating the latitude and longitude read out in the step S101 and the date and time acquired in the step S123 are visualized.

In a step S129, a position information image is created by combining the icon IC specified in the step S121, the background BG specified in the step S125 and the character strings visualized in the step S127. Image data showing the created position information image is written into the SDRAM 32 through the memory control circuit 30.

In a step S131, the header of the still image file is created by using the acquired latitude, longitude, date and time. The latitude, longitude, date and time are described in the Exif tag in the header.

In a step S133, the recording process is executed by using the header thus created. In the recording process, the still image file is created within the recording medium 40. Image data showing the created position information image is read out from the SDRAM 32 by the I/F 38 activated in association with the position recording process, and is written into the created still image file. Upon completion of the process in the step S133, thereafter, the process returns to the routine in an upper hierarchy.

As can be seen from the above-described explanation, the image sensor 16 captures the scene. The GPS device 52 and the sub CPU 44 measure the current position. The main CPU 26 creates the first image representing the scene captured by the image sensor 16 in response to the first instruction, and creates the second image including the first partial image associated with the position measured by the GPS device 52 and the sub CPU 44, in response to the second instruction. Moreover, the main CPU 26 assigns the position information indicating the position measured by the GPS device 52 and the sub CPU 44 to each of the first image and the second image.

When the first instruction is accepted, the first image representing the scene and the position information assigned thereof are acquired. Moreover, when the second instruction is accepted, the second image including the first partial image associated with the current position and the position information assigned thereof are acquired. Thereby, it becomes possible to execute the common image reproducing process referring to the position information to the first image and the second image. Thus, the image reproducing performance is improved.

It is noted that, in this embodiment, the current position is measured by using the GPS device 52. However, a gyro sensor may be arranged in the digital camera 10 so as to correct the current position measured by the GPS device 52 by using a detected result of the gyro sensor.

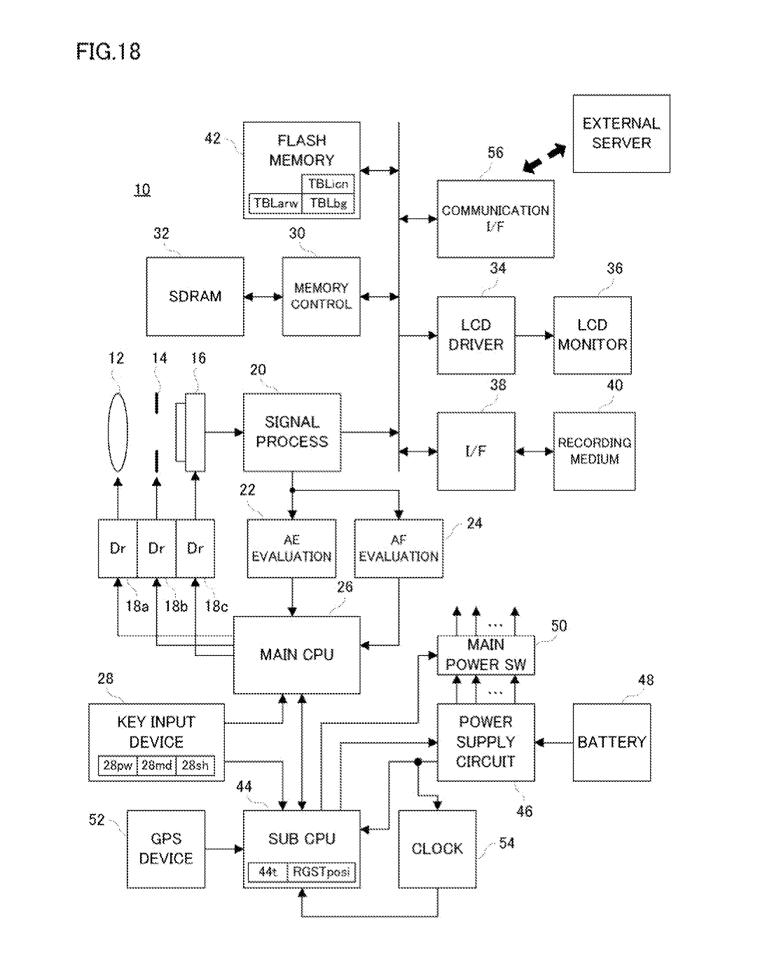

Moreover, in this embodiment, the control programs equivalent to the multi task operating system and the plurality of tasks executed thereby are previously stored in the flash memory 42. However, a communication I/F 56 may be arranged in the digital camera 10 as shown in FIG. 18 so as to initially prepare a part of the control programs in the flash memory 42 as an internal control program whereas acquire another part of the control programs from an external server as an external control program. In this case, the above-described procedures are realized in cooperation with the internal control program and the external control program.

Moreover, in this embodiment, the sub CPU 44 executes the tasks according to the flowcharts shown in FIG. 11 to FIG. 12, and the processes executed by the CPU 26 are divided into a plurality of tasks including the main task shown in FIG. 13 and the imaging task shown in FIG. 14 to FIG. 15. However, these tasks may be further divided into a plurality of small tasks, and furthermore, a part of the divided plurality of small tasks may be integrated. Moreover, when a transferring task is divided into the plurality of small tasks, the whole task or a part of the task may be acquired from the external server.

Moreover, in this embodiment, the present invention is explained by using a digital camera, however, a digital video camera, a personal computer, a portable electronic device with camera (cell phone units or a smartphone having a camera function, for example) may be applied to.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera comprising:
an imager which captures a scene;
a positioner which measures a current position;
a first creator which creates a first image representing the scene captured by said imager in response to a first instruction;
a second creator which creates a second image including a first partial image associated with the position measured by said positioner, in response to a second instruction; and
an assigner which assigns position information indicating the position measured by said positioner to each of the first image created by said first creator and the second image created by said second creator.

2. An electronic camera according to claim 1, further comprising:
a first instruction issuer which issues the first instruction in response to a user operation; and
a second instruction issuer which regularly issues the second instruction, wherein said measurer includes a first measuring processor which executes a measuring process in response to the first instruction and a second measuring processor which executes the measuring process in response to the second instruction.

3. An electronic camera according to claim 1, further comprising an acquirer which acquires current date and time, wherein the second image further includes a second partial image associated with the date and time acquired by said acquirer.

4. An electronic camera according to claim 3, wherein the first partial image is equivalent to an image on which information indicating the position measured by said measurer is described, and the second partial image is equivalent to an image on which information indicating the date and time acquired by said acquirer is described.

5. An electronic camera according to claim 1, further comprising:
a detector which detects the position information assigned by said assigner from an image; and
a restrictor which restricts a creating process of said second creator when a difference between a position indicated by the position information detected by said detector and the position measured by said measurer is equal to or less than a predetermined value.

6. An image creating program recorded on a non-transitory recording medium in order to control an electronic camera provided with an imager which captures a scene, the program causing a processor of the electronic camera to perform the steps comprising:
a positioning step of measuring a current position;
a first creating step of creating a first image representing the scene captured by said imager in response to a first instruction;
a second creating step of creating a second image including a first partial image associated with the position measured by said positioning step, in response to a second instruction; and
an assigning step of assigning position information indicating the position measured by said positioning step to each of the first image created by said first creating step and the second image created by said second creating step.
